(19) United States
(12) Patent Application Publication
(10) Pub. No.: US 2026/0320466 A1
(43) Pub. Date: Oct. 15, 2026

(54) METHOD FOR NOISE-ERROR MITIGATION, COMPUTING SYSTEM AND COMPUTER PROGRAM PRODUCT

(71) Applicant: IQM FINLAND OY, Espoo (FI)

(72) Inventors: Amin HOSSEINKHANI, München (DE); Alessio CALZONA, München (DE); Adrian AUER, München (DE); Ines DE VEGA, München (DE)

(21) Appl. No.: 19/485,822

(22) PCT Filed: May 19, 2023
(86) PCT No.: PCT/EP2023/063520

§ 371 Date: Nov. 19, 2025

(51) Int. Cl. G06N 10/70; G06N 10/20

(52) U.S. Cl. CPC G06N 10/70; G06N 10/20

(57) ABSTRACT

The present invention is related to a method for mitigating errors caused by noise in a quantum circuit executed by a quantum processor and to a computing system and to a computer program for carrying out said method.

The present invention is related to a method for noise-error mitigation, to a computing system and to a computer program for carrying out said method and to a computer-readable carrier.

Error mitigation is expected to play a crucial role in the noisy intermediate-scale quantum (NISQ) era in which performing quantum error correction is not yet possible due to hardware noise and lack of a sufficient number of qubits. In contrast to error correction that reduces the error of logical qubits, the idea of quantum error mitigation (QEM) is to reduce the impact of the quantum noise on the execution of a quantum circuit, in particular, on the estimation of an expectation value of a quantity of interest.

A variety of different error mitigation techniques exist in the art. A central feature that distinguishes different error mitigation techniques is whether a precise knowledge of the noise in the hardware is required or not. One method that requires the knowledge of the underlying noise or noise model is Probabilistic Error Cancellation (PEC) introduced by K. Temme et. al., “Error Mitigation for Short-Depth Quantum Circuits”, Physical Review Letters 119, 180509 (2017). The core idea is to represent the ideal circuit as a quasi-probabilistic mixture of real, noisy circuits associated with quasi probabilities qₗ. The real numbers qₗ can be efficiently derived given specific error models, assuming that the experimentalist has full knowledge of the model. The calculation of the estimator for the ideal circuit requires the execution of the noisy circuits that are sampled from the set of noisy ones. Having an accurate noise model is, however, very difficult.

In “Practical Quantum Error Mitigation for Near-Future Applications” by S. Endo et. al., Physical Review X8, 031027 (2018) the method of Probabilistic Error Cancellation is improved by applying Gate Set Tomography (GST). It is, however, very time-consuming to perform GST, especially for multi-qubit operations. Furthermore, it is well known that due to the drift of the parameters, one needs to repeat characterizing the system, i.e., in this case, ideally one needs to redo GST before performing PEC.

A drawback of all the methods proposed above is that they rely on the assumption of a certain noise or noise model. In practice, these models may not capture the noise of the quantum processor sufficiently well, so that the error mitigation only partly removes the effect of the noise. Furthermore, the overhead of performing PEC grows exponentially with the qubit number n and circuit depth d. As such, even when the noise-model is accurately given, performing PEC is challenging for large and deep circuits.

To overcome these drawback, noise-agnostic error mitigation techniques have been proposed in the art. These methods do not require a knowledge of the underlying noise, as its effect is approximately found using a set of quantum circuits that is in some way linked to a target circuit which is the quantum circuit of interest. Further, the overhead of performing these methods can be smaller than PEC.

One noise-agnostic error mitigation technique is Zero Noise Extrapolation (ZNE) proposed in “Error Mitigation for Short-Depth Quantum Circuits” by K. Temme et. al., Physical Review Letters 119, 180509 (2017) and “Efficient Variational Quantum Simulator incorporating active Error Minimisation” by Y. Li et. al. Physical Review X, 7021050 (2017). In ZNE, the quantity of interest, in particular, an estimator value for an expectation value of an observable is measured for several quantum circuits, each being associated with a value of a dimensionless noise scale factor. These estimator values are used to estimate the noiseless expectation value by extrapolation to the zero-noise limit. An application of this error-mitigating protocol has been demonstrated on a superconducting quantum computer for Hamiltonians of quantum chemistry and magnetization in “Error mitigation extends the computational reach of a noisy quantum processor” by A. Kandala et. al., Nature 567, 491 (2019).

A method for mitigating depolarizating noise using ZNE is proposed in “Mitigating Depolarizing Noise in Quantum Computers with Noise-Estimation Circuits” by M. Urbanek et. al., Physical Review Letters 127, 270502 (2021). There, the rate of depolarizing noise is first estimated using a noise-estimation circuit. This rate is used to mitigate the effect of depolarizing noise from the obtained expectation value. This depolarizing-noise-mitigated expectation value is then used as an input for zero noise extrapolation. The accuracy of this approach depends on how well the depolarizing noise model describes the noise present in the quantum processor.

An alternative noise-agnostic error mitigation technique is Clifford Data Regression proposed in “Error mitigation with Clifford quantum-circuit data” by P. Czarnik et. al., Quantum 5, 592 (2021). There, a set of training quantum circuits composed largely of Clifford gates and being related to the quantum circuit of interest is defined. Then, for each of said training quantum circuits, an expectation value of an observable of interest is evaluated when said training circuit is executed on a classical computer, respectively on a quantum computer, to thereby obtain the exact version, respectively the noisy version of the estimator of the expectation value. Next, one constructs a model for the noise-free value of the observable for the quantum circuit of interest from the noisy expectation values and determines the parameters for the model by regression or machine-learning methods.

Ideas of Zero-Noise Extrapolation and Clifford Data Regression are combined in a method called variable-noise Clifford Data Regression proposed in “Unified approach to data-driven quantum error mitigation”, by A. Lowe et. al., Physical Review Research 3, 033098 (2021).

While ZNE and the related techniques are in general a powerful tool for error mitigation, it suffers from a number of challenges. The estimation using ZNE has a bias error originating from the mathematical model used to fit the noisy data. Ideally, one wishes to use a low-degree polynomial for the fitting since a higher-degree polynomial requires a larger number of noisy data which, in turn, exponentially increases the cost of ZNE in terms of the required executions of the quantum circuit (shots). Furthermore, the extrapolation relies on the accurate control of amplifying the noise. One can argue that the current gate-level and pulse-level methods to control the noise strength require some strong assumptions about the nature of the noise that can easily be invalid, in particular in the presence of time-dependent noise. Such inaccuracies in controlling the noise strength in turn contribute to the bias error of the error mitigation.

Due to these problems in the prior art, it is therefore an object of the present invention to propose an improved method for mitigating errors caused by noise in a target quantum circuit executed by a quantum processor which is noise-agnostic and to further propose a computing system and a computer program for carrying out said method.

According to a first aspect of the present invention, there is provided a method for mitigating errors caused by noise in a target quantum circuit P executed by a quantum processor, said method comprising:
i) deriving from said target quantum circuit P at least one auxiliary quantum circuit Aᵢ, i=1, . . . , N_{A}≥1, each auxiliary quantum circuit being efficiently classically simulable;
ii) selecting a plurality of execution strategies Sₘ, m=1, . . . , M for the quantum circuits, each execution strategy corresponding to an execution of the quantum circuit with an associated value λₘ≥1 of a noise strength λ;
iii) for each execution strategy Sₘ executing the target quantum circuit P by said quantum processor according to the execution strategy to thereby obtain an estimator value E_{O}(P,λₘ) of an expectation value of an observable O associated with the value λₘ of said execution strategy Sₘ, and executing each auxiliary quantum circuit Aᵢ by said quantum processor according to the execution strategy Sₘ to thereby obtain an auxiliary estimator value E_{O}(Aᵢ,λₘ) of the expectation value of the observable O associated with the value λₘ of said execution strategy Sₘ;
iv) simulating, by a classical computer, an execution of each auxiliary quantum circuit Aᵢ to thereby obtain a noise-free auxiliary estimator value E_{O}(Aᵢ,0) of the expectation value of the observable O;
v) transforming an original set

$${\{ {E}_{O} ( P , {λ}_{m} ) )}_{m = 1}^{M}$$

of the estimator values E_{O}(P,λₘ) for each value λₘ on the basis of the auxiliary estimator values E_{O}(Aᵢ,0), E_{O}(Aᵢ,λₘ) to thereby obtain a set of transformed estimator values

$${\{ {E}_{T} ( {λ}_{m} ) \}}_{m = 1}^{M}$$

such that the transformed estimator values have a reduced value for a measure of dispersion compared to the estimator values of the original set;
vi) defining a fitting model for a data set

$${\{ ( {λ}_{m} , {E}_{T} ( {λ}_{m} ) ) \}}_{m = 1}^{M}$$

of M tuples of the values λₘ of the noise strength λ and the associated transformed estimator values E_{T}(λₘ), fitting said fitting model to the data set to thereby estimate the zero-noise limit, λ=0 and to thereby infer an error mitigated value E_{EM}(P,0) of the estimator value of the expectation value of the observable O.

A quantum circuit may comprise instructions related to a number of n qubits, a certain initial state of said n qubits, an application of a unitary transformation by an application of a predetermined gate sequence of quantum gates, each quantum gate preferably acting on a small number of qubits of the n qubits, each quantum gate being preferably a single-qubit gate or a two-qubit gate, and a measurement of an observable O of the final state of the n qubits after the application of the gate sequence. A quantum circuit may be understood as the implementation of a quantum algorithm.

The quantum processor comprises a register of n qubits, means for applying quantum gates, preferably means for applying single-qubit gates and two-qubit gates, and measurement means for measuring the observable O of the state of the n qubits. In one example, the observable O may be measured by measuring each of the n qubits in the computational basis.

The execution of the quantum circuit by the quantum processor comprises preparing the n qubits in the qubit register in the initial state according to the instructions of the quantum circuit, applying the unitary transformation by an application of an execution gate sequence according to the instructions of the quantum circuit (i.e., on the basis of the predetermined gate sequence) and the execution strategy by the means for applying quantum gates and measuring the final state of the n qubits obtained after the application of the unitary transformation with the measurement means according to the instructions of the quantum circuit to thereby measure a value of the observable O. Due to the probabilistic nature of quantum mechanics, the quantum circuit is repeatedly executed many times (many shots) to thereby obtain an estimator value of the expectation value of the observable. I.e., when the final state of the quantum circuit is described by a density operator ρ, the expectation value of the observable O with associated hermitian operator Ô is given by tr[ρÔ]. When the outcome of the measurement of the observable O for the j-th execution of the quantum circuit (j-th shot) is Oⱼ, the expectation value may be approximated by an estimator value which is a function of the measurement outcomes Oⱼ. In one example, the estimator may be the mean, and the estimator value may be the mean value of the observable, i.e.,

$$\frac{1}{N} {\sum }_{j = 1}^{N} {O}_{j}$$

wherein N is the number of shots.

The estimator value of the observable associated with a quantum circuit Q=P or Q=Aᵢ and the value λₘ of the noise strength associated with the execution strategy Sₘ is denoted by E_{O}(Q,λₘ). As the execution strategy Sₘ is associated with a value λₘ of the noise strength, one may also write E_{O}(Q,Sₘ)=E_{O}(Q,λₘ). I.e., the estimator value depends on the execution strategy.

The target quantum circuit P is a quantum circuit of interest, and the estimator value of the expectation value of the observable O may be related to the solution of a computational problem. Thus, the goal of QEM is to obtain an approximation of the estimator value in the zero-noise limit, E_{O}(P,λ=0). The target quantum circuit P comprises instructions for realizing a target unitary transformation by a predetermined target gate sequence. The auxiliary quantum circuit comprises instructions for realizing an auxiliary unitary transformation by a predetermined auxiliary gate sequence.

According to the method of the present invention, the quantum circuits are executed according to an execution strategy associated with a value λᵢ of the noise strength λ. An execution strategy specifies how the unitary transformation of the quantum circuit is realized by the quantum processor, e.g., by modifying the predetermined gate sequence of the quantum circuit while still realizing the same unitary transformation and/or by modifying the implementation of the quantum gates, e.g., by different gate application times. In the absence of noise (λ=0), the execution strategy would have no influence on the outcome of the computation, as in theory each execution strategy results in the realization of the same unitary transformation of the qubits of the register, transforming their state from the initial state to the final state. However, in NISQ quantum processors, the execution of a quantum circuit is inevitably noisy. The different execution strategies introduce different amounts of noise in the execution of the quantum circuit by the quantum processor as quantified by the value λᵢ of the noise strength λ, e.g., due to a different number of executed quantum gates. The noise strength λ is a dimensionless parameter. The value λᵢ of the noise strength associated with a certain execution strategy may be assigned by a user of the method based on well-thought considerations. For example, different execution strategies may comprise changing physical parameters when implementing the quantum gates by the quantum processor or by inserting a sequence of abundant gates in the predetermined gate sequence of the quantum circuit, said sequence of abundant quantum gates being equivalent to the identity if operated noiselessly. Concrete examples of different execution strategies and their associated value λᵢ of the noise strength will be presented below.

In one example, the execution strategies may be selected by a user of the method and provided to the classical computer and/or the quantum processor. In another example, said execution strategies may be selected by the classical computer, e.g., on the basis of a user input, e.g, on the basis of a desired value of the noise strength.

In one example, there may be an intrinsic or optimal execution strategy of the target quantum circuit P by the quantum processor for which it is expected that the error of the estimator value of the expectation value of the observable O is minimal. For example, this optimal/intrinsic execution strategy may be obtained for a special realization of the unitary transformation of the target quantum circuit by an execution of a particular gate sequence, e.g. a special sequence of one- and two qubit gates, wherein each quantum gate is implemented in an optimal way on the quantum processor. For the target quantum circuit, this special gate sequence may be the target gate sequence, and for the auxiliary quantum circuit, this special gate sequence may be the auxiliary gate sequence. Further, the application time for the quantum gates may be optimized for this optimal execution strategy. This optimal/intrinsic execution strategy may be associated with a value of λ₁=1 of the noise strength. Then, every other execution strategy is not the optimal one, and is associated with a noise strength λᵢ>1. Thus, different execution strategies may comprise different realizations of the unitary transformation of the quantum circuit. For example, if the optimal/intrinsic execution strategy with value λ₁=1 is by an application of the target gate sequence, execution strategies with a value of λᵢ>1 may comprise inserting gate sequences in the target gate sequence which are equal to the identity in the zero-noise limit. Additionally, or alternatively, the quantum gates may be realized differently by the quantum processor, e.g., via different gate times.

Executing the target quantum circuit P and each auxiliary quantum circuit according to each of a plurality of execution strategies to thereby obtain an estimator value and an auxiliary estimator value of the observable O for each execution strategy Sₘ is known in the art. It is well-known that quantifying λₘ for a given execution strategy, while physically motivated, may have an inevitable uncertainty, resulting in an uncertainty of the noise-mitigated estimator value.

The at least one auxiliary quantum circuit is preferably derived from the target quantum circuit P such that the target quantum circuit and the auxiliary quantum circuit have a similar circuit structure. Deriving the auxiliary quantum circuit may comprise inserting and/or replacing quantum gates in the target gate sequence of the target quantum circuit and/or removing quantum gates from the target gate sequence of the target quantum circuit to thereby obtain the auxiliary gate sequence of the auxiliary quantum circuit. For example, deriving the at least one auxiliary quantum circuit may comprise deriving an auxiliary quantum circuit which has the same sequence of two qubit gates, in particular the same sequence of CNOT-gates as the target quantum circuit. However, the invention is not limited to this. In principle any quantum circuit acting on the same number of qubits and measuring the same observable O as the target quantum circuit may be chosen as the auxiliary quantum circuit. In one example, said deriving of said at least one auxiliary quantum circuit may be performed by or assisted by the classical computer. Additionally, or alternatively, said deriving of said at least one auxiliary quantum circuit may be performed by the user of the method. The user may then provide information defining the auxiliary quantum circuits to the classical computer and/or the quantum processor.

In one example, a single auxiliary quantum circuit is derived from the target quantum circuit P and executed by the quantum processor. This example has a particularly small computational cost. Alternatively, several (N_{A}>1) auxiliary quantum circuits Aᵢ may be derived from the quantum circuit P and executed by the quantum processor and the classical computer. While computationally more costly, it may be possible to significantly reduce the value of the measure of dispersion by using auxiliary estimator values of several auxiliary circuits for the transformation in step v) of the method.

The auxiliary quantum circuits are efficiently classically simulable. I.e., their execution may be simulated in a time which is polynomial in the number n of qubits on a classical computer. Thus, the noise-free auxiliary estimator values E_{O}(Aᵢ,O) of the expectation value of the observable O may be determined efficiently using the classical computer.

According to the method of the present invention, the original set of estimator values

$${\{ {E}_{O} ( P , {λ}_{m} ) ]}_{m = 1}^{M}$$

comprising the estimator values E_{O}(P,λₘ) for each value λₘ are transformed on the basis of the noisy and the noise-free auxiliary estimator values E_{O}(Aᵢ,O), E_{O}(Aᵢ,λₘ) to thereby obtain a set of transformed estimator values

$${\{ {E}_{T} ( {λ}_{m} ) \}}_{m = 1}^{M}$$

such that the transformed estimator values have a reduced value for a measure of dispersion compared to the estimator values of the original set. I.e., the deviation or spread of the transformed estimator values E_{T}(λₘ) from each other is smaller than the deviation or spread of the (original) estimator values E_{O}(P,λₘ) from each other. Each transformed estimator value E_{T}(λₘ) thus depends on the estimator value E_{O}(P,λₘ), and the noisy auxiliary estimator values E_{O}(Aᵢ,λₘ) for the value λₘ of the noise strength and the noise-free estimator values E_{O}(Aᵢ,O). The auxiliary estimator values are thus used to reduce the impact of noise on the transformed estimator values. The transforming of the original set of the estimator values may be performed by the classical computer in one example.

The method according to the present invention further comprises defining a fitting model for a data set

$${\{ ( {λ}_{m} , {E}_{T} ( {λ}_{m} ) ) \}}_{m = 1}^{M}$$

of M tuples of the values λₘ of the noise strength A and the associated transformed estimator values E_{T}(λₘ). As the dispersion for the transformed estimator values is small, a low-degree polynomial may be a good fitting function. This may greatly reduce the bias error. In one example, said fitting model may be defined by a user. The user may then provide the fitting model to the computer for further processing. In another example, said fitting model may be defined by the computer on the basis of the data set.

The fitting model is fitted to the data set to thereby estimate the zero-noise limit, λ=0 and to thereby infer an error mitigated value E_{EM}(P,O) of the estimator value of the expectation value of the observable O for the target quantum circuit P in the zero-noise limit. The error mitigated value E_{EM}(P,0) may be inferred by extrapolating the fitting model to the zero-noise limit. As the dispersion of the transformed estimator values is small, the estimation of the zero-noise limit is very accurate. Furthermore, inaccuracies in the values of the noise strength have a reduced effect on the estimation of the noise-free estimator value. In one example, there may be only two execution strategies. Even in this case, the estimation of the zero-noise limit may be very accurate due to the small dispersion of the transformed estimator values. As in this example, the quantum circuits are executed according to only two execution strategies on the quantum processor, the computational cost of this example is minimal. In one example, said fitting to the data set may be performed by the classical computer.

In one embodiment of the method according to the present invention, transforming said original set

$${\{ {E}_{O} ( P , {λ}_{m} ) \}}_{m = 1}^{M}$$

may comprise multiplying each estimator value E_{O}(P,λₘ) of said set with a value W(λₘ) of a re-scaling function W which depends on the auxiliary estimator values, E_{T}(P,λₘ)=W(λₘ)E_{O} (P,λₘ). I.e., W(λₘ)=W(E_{O}(A,0), E_{O}(Aᵢ,λₘ), . . . , E_{O}(A_{N}_{_{A}},0), E_{O}(A_{N}_{_{A}},λₘ)). Preferably the re-scaling function is defined so that its value is 1 in the zero-noise limit λ→0, i.e., W(0)=1. This may always be achieved by properly normalizing the re-scaling function. Then, the error mitigated value E_{EM}(P,0) of the estimator value of the expectation value of the observable O may be readily determined from the estimated zero-noise limit of the transformed estimator value E_{T}(P,0). The error mitigated value E_{EM}(P,0) of the estimator value of the expectation value of the observable O is identical to E_{T}(P,0) if the value of the re-scaling function is 1 in the zero-noise limit.

In a further embodiment, said re-scaling function W may be a member of a parametric family of functions W_{α} with a real parameter α, and said method may further comprise determining an optimal value α* for said parameter α such that the dispersion of the transformed estimator values transformed with the function W_{α*} is minimized. In this way, the accuracy of the error mitigation technique may be further improved. Minimization may be performed by a standard minimization technique using a classical computer. One example of such a technique is the Nelder-Mead algorithm for minimization.

In one example, said real parameter α may comprise 2N_{A}≥1 real parameters nᵢ and cᵢ, i=1, . . . N_{A}, the re-scaling function W may be a member of the parametric family of functions

$${W}_{\{ {c}_{i} , {n}_{i} \}} ( {λ}_{m} ) = \frac{1}{{\sum }_{i = 1}^{{N}_{A}} {c}_{i}} {\sum }_{i = 1}^{{N}_{A}} {{c}_{i} ( \frac{{E}_{O} ( {A}_{i} , 0 )}{{E}_{O} ( {A}_{i} , {A}_{m} )} )}^{{n}_{i}} ,$$

and wherein at least one of the parameters nᵢ and/or at least one of the parameters cᵢ may be determined so as to minimize the dispersion of the transformed estimator values. The value of this re-scaling function is 1 in the zero-noise limit, as E_{O}(Aᵢ,λₘ)→E_{O}(Aᵢ,0) in the zero-noise limit, λₘ→0. A multiplication of this re-scaling function with the estimator values E_{O}(P,λₘ) results in terms of the form

$$\frac{{E}_{O} ( P , {λ}_{m} )}{{( {E}_{O} ( {A}_{i ,} {λ}_{m} ) )}^{n}} .$$

If the auxiliary quantum circuits Aᵢ have a similar noise behavior as the target quantum circuit P, the dependence of such terms on λₘ should be small for some value of n, thereby resulting in a small value of the measure of dispersion for the transformed estimator values. In one example only the parameters nᵢ are determined to minimize the dispersion while the parameters cᵢ are fixed. In another example, only the parameters cᵢ are determined to minimize the dispersion while the parameters nᵢ are fixed.

In the case of a single auxiliary circuit A₁, one example of the re-scaling function may include

$$W ( {λ}_{m} ) = {( \frac{{E}_{O} ( {A}_{1} , {λ}_{m} )}{{E}_{O} ( {A}_{i ,} {λ}_{m} )} )}^{{n}_{1}}$$

wherein the parameter n₁ is determined to minimize the dispersion. One example in the case of two auxiliary circuits A₁ and A₂ may include

$$W ( {λ}_{m} ) = \frac{{c}_{1}}{{c}_{1} + {c}_{2}} {( \frac{{E}_{O} ( {A}_{1} , 0 )}{{E}_{O} ( {A}_{1} , {λ}_{m} )} )}^{{n}_{1}} + \frac{{c}_{2}}{{c}_{1} + {c}_{2}} {( \frac{{E}_{O} ( {A}_{2} , 0 )}{{E}_{O} ( {A}_{2} , {λ}_{m} )} )}^{{n}_{2}} ,$$

wherein the parameters n₁, n₂, c₁, c₂ are determined so as to minimize the dispersion. One example in the case of N_{A} auxiliary quantum circuits may include

$$W ( {λ}_{m} ) = \frac{1}{{N}_{A}} {\sum }_{i = 1}^{{N}_{A}} {( \frac{{E}_{O} ( {A}_{i} , 0 )}{{E}_{O} ( {A}_{i} , {λ}_{m} )} )}^{{n}_{i}} ,$$

where the N_{A} parameters nᵢ are determined so as to minimize the dispersion. In this way, the bias error of the error mitigated estimator value may be minimized efficiently.

In one embodiment of the method of the present invention, the fitting model may comprise a model function which is a polynomial in the noise strength. In one example, the model function may be a low-degree polynomial in the noise strength, e.g., a polynomial of degree one, two or three. In one example, the model function may be a linear function ƒ(λ)=a₁λ+a₂ with fitting parameters a₁ and a₂. Such a model is particularly well-suited when the dispersion of the transformed estimator values transformed with the function W_{α*} is minimized, and/or when only two execution strategies are used. Alternatively, the fitting model may comprise a model function which is an exponential function in the noise strength. In one example, the model function may be. ƒ(λ)=b₁e^{-b}^{₂}^{λ}+b₃ with fitting parameters b₁, b₂, b₃.

In one example, the measure of dispersion may be proportional to the variance, the standard deviation or the mean absolute difference. If the measure of dispersion is proportional to the variance or the standard deviation, a mean value

$$μ = \frac{1}{M} {\sum }_{m = 1}^{M} {E}_{O} ( P , {λ}_{m} )$$

of the estimator values and a mean value

$${μ}_{T} = \frac{1}{M} {\sum }_{m = 1}^{M} {E}_{T} ( {λ}_{m} )$$

of the transformed estimator values is to be calculated. The value of the variance for the estimator values is given by

$${D}_{V} = \frac{1}{M} {\sum }_{m = 1}^{M} {( {E}_{O} ( P , {λ}_{m} ) \to μ )}^{2} ,$$

while the value of the variance for the transformed estimator values is given by

$${D}_{V , T} = \frac{1}{M} {\sum }_{m = 1}^{M} {( {E}_{T} ( {λ}_{m} ) - {μ}_{T} )}^{2} .$$

The value for the standard deviation of the estimator values is given by \sqrt{D_{V}} and the value for the standard deviation of the transformed estimator values is given by \sqrt{D_{V,T}}. If the measure of dispersion is proportional to the mean absolute difference, the value of the measure of dispersion for the estimator values is proportional to Σ_{i,j}|E_{O}(P,λᵢ)−E_{O}(P,λᵢ)|, and the value of the measure of dispersion for the transformed estimator values is proportional to Σ_{i,j}∥E_{T}(λᵢ)−E_{T}(λⱼ)|. Another possible measure of dispersion is defined so that its value for the estimator values is proportional to Σₘ|E_{O}(P,λₘᵢₙ)−E_{O}(P,λₘ)|, wherein λₘᵢₙ is the minimal value of the noise strength for all execution strategies, and wherein the value of the measure of dispersion for the transformed estimator values is proportional to ΣₘE_{T}(λₘᵢₙ)−E_{T}(λₘ)|. The invention is, however, not limited to the above examples, and any other measure of dispersion may be used.

In principle, the at least one auxiliary quantum circuit may be arbitrarily derived from said target quantum circuit P as long as they involve the same number of qubits and the measurement of the same observable O. In a preferred embodiment, the target quantum circuit P may comprise a target gate sequence with a first quantum gate, said first quantum gate acting on at least one qubit, and wherein deriving at least one of said auxiliary circuits Aₐ from said target quantum circuit P may comprise replacing said first quantum gate by a replacement gate thereby obtaining an auxiliary gate sequence, said replacement gate acting preferably on the same qubits as the first quantum gate. I.e., when the first quantum gate is a p-qubit gate (e.g. 1-qubit gate) acting on the p qubits q₁ . . . , qₚ, the replacement gate is preferably a p-qubit gate acting on the same p qubits q₁ . . . , qₚ. In one embodiment, several quantum gates, i.e., 2, 3 or more quantum gates of the target gate sequence may each be replaced by a particular replacement gate to thereby obtain the auxiliary gate sequence.

Preferably, said first quantum gate may comprise a non-Clifford gate, and said replacement gate may comprise a Clifford gate. In one embodiment, all non-Clifford gates may be replaced by a replacement gate comprising a Clifford gate. In one embodiment, the replacement gate may be a Clifford gate. In a further embodiment, the replacement gate may be a Clifford gate which is the closest Clifford gate to said first quantum gate. Alternatively, an angle of said Clifford gate may be randomly selected. The angle θ_{C} of the Clifford gate may be randomly selected from a set of all Clifford angles, i.e

$${θ}_{C} ϵ \{ 0 , \frac{π}{2} , π , \frac{3 π}{2} \} ,$$

based on a user-defined distribution. An example of user-defined distribution is:

e^{-∇θ}^{²}^{/σ}^{²}

in which ∇θ is the difference between the non-Clifford angle of the first quantum gate and the set of Clifford angles θ_{C}, and the width σ is arbitrarily defined by a user of the method. In the special case where σ=0, using this distribution is equivalent to using the closest Clifford gate for the replacement.

If all quantum gates of the target gate sequence are replaced by Clifford gates, the derived auxiliary quantum circuit is classically simulable. However, there are also other possibilities to derive a classically simulable auxiliary quantum circuit from the target quantum circuit.

In one embodiment, the target gate sequence may comprise a plurality of non-Clifford gates, and wherein deriving at least one of said auxiliary quantum circuits from said target quantum circuit P comprises replacing each non-Clifford gate of a first number of the non-Clifford gates by a Clifford gate and keeping each non-Clifford gate of a second number of the non-Clifford gates. The first number and/or the second number may be non-zero in one example. I.e., the auxiliary gate sequence comprises at least the first number of Clifford gates and the second number of non-Clifford gates. In a preferred example, the auxiliary gate sequence differs from the target gate sequence only in that each of the non-Clifford gates of the first number of non-Clifford gates is replaced by a Clifford gate. Preferably, the second number is small so that efficient classical simulation of the respective auxiliary quantum circuit is feasible with a classical computer. Preferably, the second number is at most 15, preferably at most 10, even more preferably at most 5. The second number may be selected by a user of the method. In one example, it may be determined randomly, e.g., by the classical computer, which non-Clifford gates are kept.

In a further embodiment, the target gate sequence may comprise a third quantum gate, and deriving at least one of said auxiliary quantum circuits from the target quantum circuit may comprise removing the third quantum gate. For example, one auxiliary quantum circuit may be derived from the target quantum circuit by removing all single-qubit gates from the target gate sequence.

In one embodiment, a first execution strategy Sᵢ associated with a first value λᵢ of the noise strength λ comprises an implementation of a second quantum gate of said gate sequence by an application of a control pulse C during an application time T by said quantum processor, and wherein a second execution strategy Sⱼ associated with a second value λⱼ of the noise strength λ which is larger than the first value of the noise strength, λⱼ>λᵢ, comprises an implementation of the second quantum gate by an application of a recalibrated control pulse C′ for a stretched application time T′=T·λⱼ/λᵢ by said quantum processor. The gate sequence is the target gate sequence for the target quantum circuit and it is the auxiliary gate sequence for the auxiliary quantum circuit. In this way, the same execution strategy is used for the target quantum circuit and the auxiliary quantum circuit.

In one embodiment, the first execution strategy Sᵢ associated with the first value λᵢ of the noise strength λ may comprise an implementation of each quantum gate Gₖ of said gate sequence by an application of a control pulse Cᵢ during an application time Tᵢ by said quantum processor, and the second execution strategy associated with a second value λⱼ of the noise strength λ which is larger than the first value of the noise strength λⱼ>λᵢ may comprise an implementation of each quantum gate Gᵢ of the gate sequence by an application of a recalibrated control pulse Cⱼ′ for a stretched application time Tⱼ′=Tᵢ*(λⱼ/λᵢ) by said quantum processor. Different execution strategies are thus realized by a pulse level control. The gate sequence is the target gate sequence for the target quantum circuit and it is the auxiliary gate sequence for the auxiliary quantum circuit. In this way, the same execution strategy is used for the target quantum circuit and the auxiliary quantum circuit.

In a further embodiment, a third execution strategy may comprise adding an additional gate sequence corresponding to an identity operation to said gate sequence, wherein preferably the additional gate sequence corresponds to a product of a unitary operation Uᵢ and its hermitian conjugate

$${U}_{i}^{†} ,$$

wherein the unitary operation or its hermitian conjugate corresponds to at least one gate of said gate sequence of said quantum circuit. The additional gate sequence may be added before or after, preferably directly before or directly after, the at least one gate in one example. The gate sequence is the target gate sequence for the target quantum circuit and it is the auxiliary gate sequence for the auxiliary quantum circuit. In this way, the same execution strategy is used for the target quantum circuit and the auxiliary quantum circuit.

In one embodiment, the unitary operation or its hermitian conjugate may correspond to all quantum gates of the gate sequence of the target and auxiliary quantum circuits, respectively. In one embodiment, the additional gate sequence may correspond to a plurality of products of unitary operations Uᵢ and the corresponding hermitian conjugate

$${U}_{i}^{†} ,$$

wherein each unitary Uᵢ or its hermitian conjugate corresponds to at least one gate of the target and the auxiliary gate sequences, respectively. In one embodiment the additional gate sequence may be the complete gate sequence of the quantum circuit. For example, if the gate sequence of the quantum circuit is represented by the unitary U and is associated with a value \tilde{λ} of the noise strength λ, then an execution strategy with the noise strength \tilde{λ}ₚ=(2p+1)\tilde{λ} may be realized by an application of the unitary operation U(UU^{†})^{p} or U(U^{†}U)^{p} or (U^{†}U)^{p}U. The gate sequence is the target gate sequence for the target quantum circuit and it is the auxiliary gate sequence for the auxiliary quantum circuit. In this way, the same execution strategy is used for the target quantum circuit and the auxiliary quantum circuit.

In one further embodiment, the method may further comprise: a fourth execution strategy comprises executing said gate sequence of the quantum circuit followed by executing the inverse of said gate sequence. The gate sequence is the target gate sequence for the target quantum circuit and it is the auxiliary gate sequence for the auxiliary quantum circuit. In this way, the same execution strategy is used for the target quantum circuit and the auxiliary quantum circuit.

Thus, the execution strategies may comprise unitary folding as described, e.g. in “Digital zero noise exploitation for quantum error mitigation” by T. Giurgica-Tiron et al., 2020 IEEE International Conference on Quantum Computing and Engineering (QCE), 306. There, for a circuit composed of d unitary layers U=L_{d} . . . L₂ L₁ wherein d represents the depth of the circuit and each block Lⱼ either represent a single layer of operation or just a single gate, “circuit folding” and “gate (or layer) folding” are described. The general circuit folding replacement rule is:

$$U \to {U}_{j} = {U ( {U}^{†} U )}^{p} {L}_{d}^{†} {L}_{i - 1}^{†} … {L}_{s}^{†} {L}_{s} … {L}_{d - 1} {L}_{d} .$$

The total number of layers of the new circuit is d(2p+1)+2s. Thus, if the original circuit is associated with a value λᵢ of the noise strength λ, the execution strategy Sⱼ which comprises the application of the gate sequence described by the unitary Uⱼ is associated with the value

$${λ}_{j} = ( 1 + \frac{2 ( p + s )}{d} ) \tilde{λ}$$

of the noise strength.

The general gate (or layer) folding replacement rule is as follows:

$$∀ j ∈ \{ 1 , 2 , … , d \} : {L}_{i} \to {{L}_{j} ( {L}_{j}^{†} {L}_{j} )}^{p} if j ∉ S , and {L}_{j} \to {{L}_{j} ( {L}_{j}^{†} {L}_{j} )}^{p + 1}$$

if j∈S, wherein S is a subset of the full set of indices such that the number of elements in S is s=ISI. The number of gates (or layers) after the application of the gate folding rule is d*(2p+1)+2s, so that this execution strategy is associated with the

$${λ}_{j} = ( 1 + \frac{2 ( p + s )}{d} ) \tilde{λ}$$

of the noise strength.

According to a second aspect of the present invention, there is provided a computing system, said computing system comprising a classical computer and a quantum processor, wherein said computing system is configured to carry out the method according the first aspect of the present invention.

In particular, the classical computer may be configured to execute instructions to thereby perform steps iv) and v) and vi), and preferably also step i) of the method according to the present invention and the quantum processor may be configured to execute the quantum circuits according to the method of the present invention, in particular according to step iii). Selecting the execution strategies according to step ii) may be assisted by a user input.

According to a third aspect of the present invention, there is provided a computer program product including instructions, which, when the program is executed by a computer system comprising a classical computer and a quantum processor, cause the computer system to carry out the method of the present invention.

According to a fourth aspect of the present invention, there is provided a computer-readable data carrier having stored thereon the computer program product according to the third aspect of the present invention.

In the following, the invention is described in more detail by way of example with reference to the figures, in which

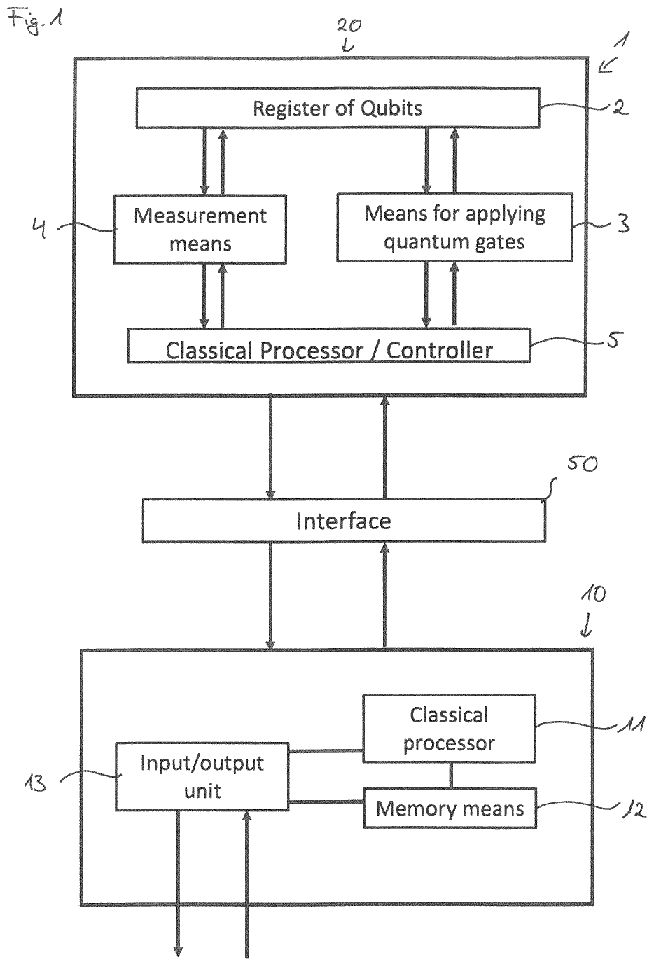

FIG. 1 depicts a schematic representation of a hybrid quantum-classical computing system according to the second aspect of the present invention,

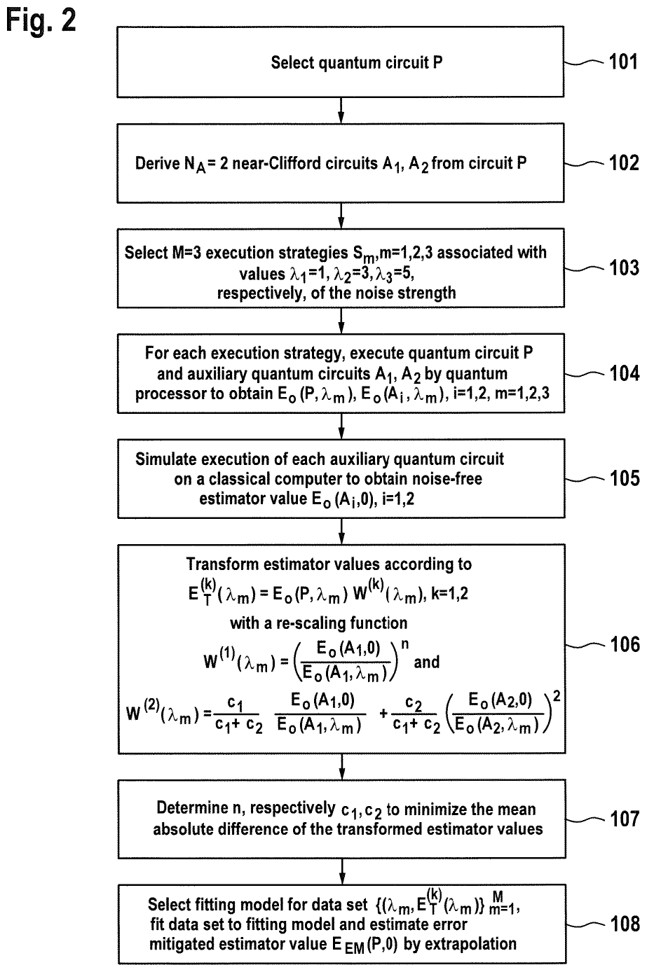

FIG. 2 depicts a flow chart of method steps of an embodiment of the method according to the first aspect of the present invention,

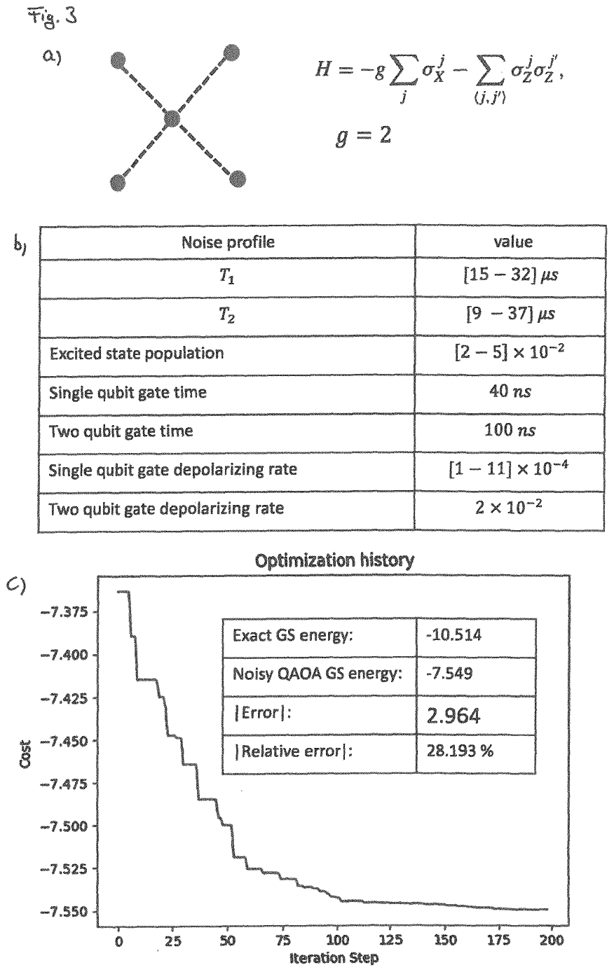

FIG. 3 depicts an example of a computational problem to which the method shown in FIG. 2 is applied,

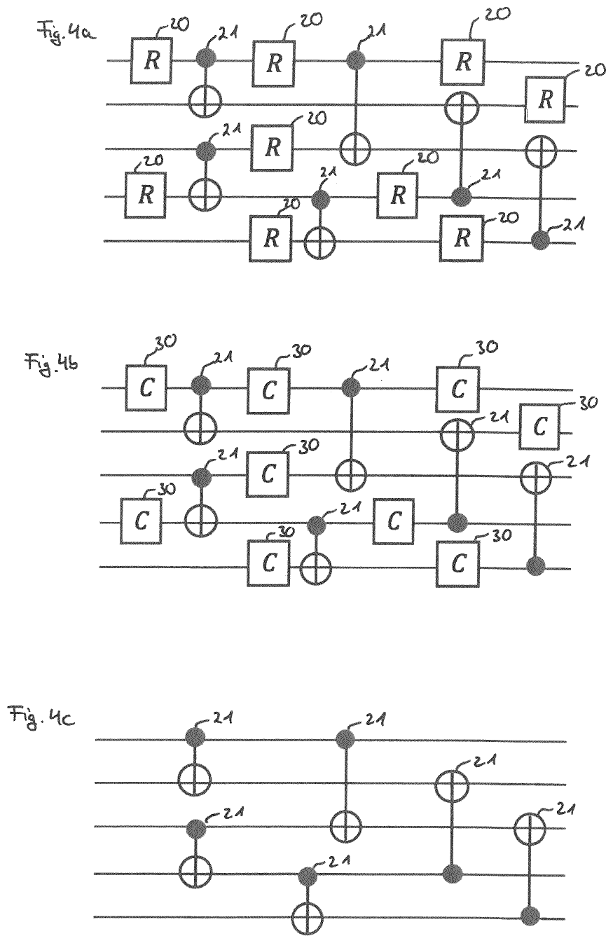

FIG. 4a depicts a schematic representation of the target quantum circuit P,

FIG. 4b depicts an example of an auxiliary quantum circuit derived from the target quantum circuit P shown in FIG. 4a,

FIG. 4c depicts another example of an auxiliary quantum circuit derived from the target quantum circuit P shown in FIG. 4a,

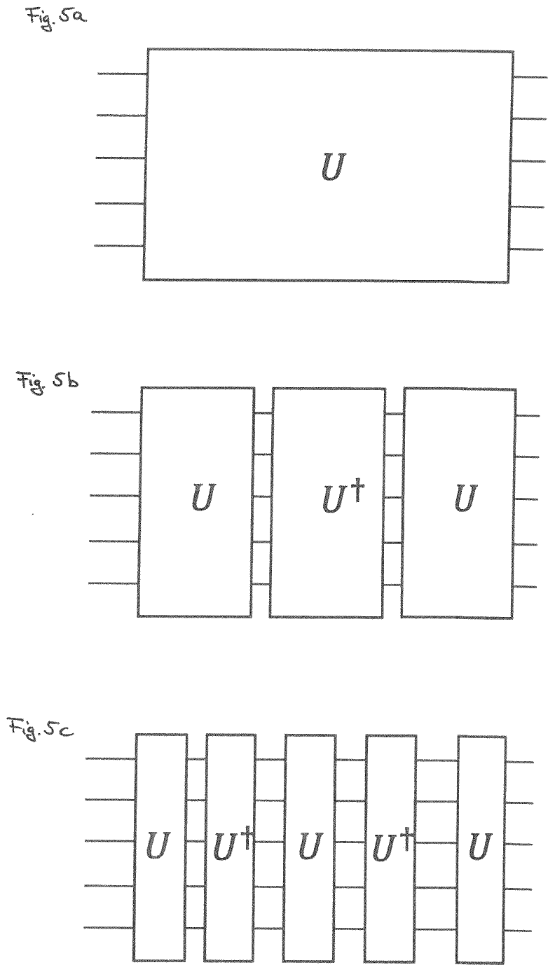

FIG. 5a depicts an example of an execution strategy for a quantum circuit, e.g. the target or auxiliary quantum circuits shown in FIGS. 4a-4c,

FIG. 5b depicts another example of an execution strategy for a quantum circuit, e.g. the target or auxiliary quantum circuits shown in FIGS. 4a-4c,

FIG. 5c depicts yet another example of an execution strategy for a quantum circuit, e.g. the target or auxiliary quantum circuits shown in FIGS. 4a-4c,

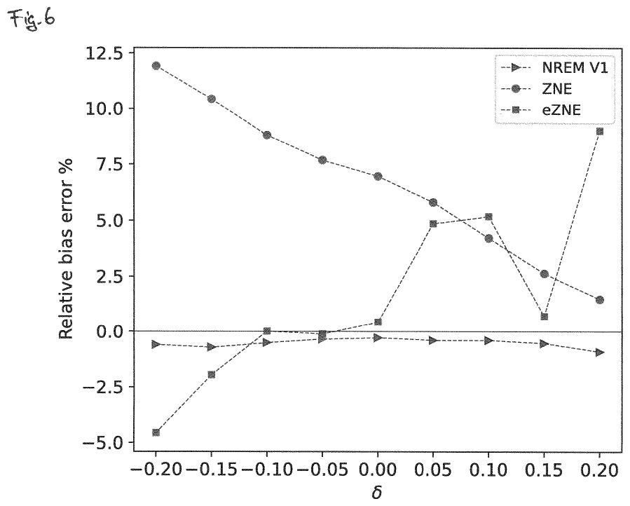

FIG. 6 depicts the influence in an uncertainty of the value of the noise strength on the bias error for three different error mitigation methods,

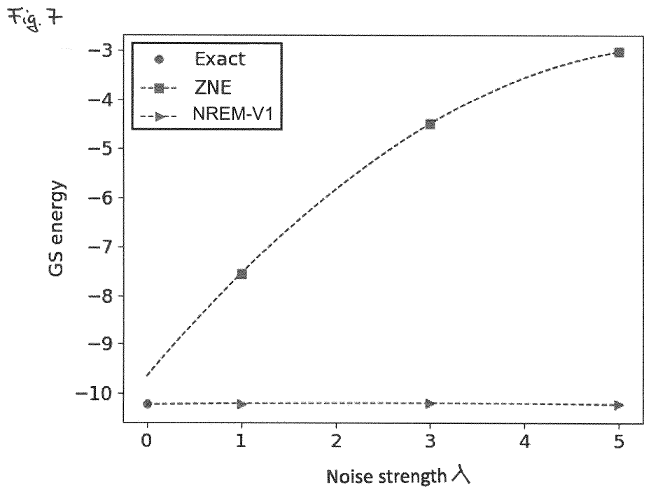

FIG. 7 depicts values of the ground state energy for the transverse Ising model of FIG. 3a as a function of the noise strength λ.

FIG. 1 depicts a schematic representation of a hybrid quantum-classical computing system 20 according to an aspect of the present invention. The computing system 20 comprises a quantum processor 1 and a classical computer 10. Furthermore, the computing system 20 comprises an interface 50 interfacing the quantum processor 1 and the classical computer 10.

The classical computer 10 comprises a classical processor 11, memory means 12 and an input/output unit 13. The classical computer 10 is operative to receive instructions specifying a target quantum circuit P which is a quantum circuit of interest, instructions on how to derive at least one classically simulable auxiliary quantum circuit Aᵢ, i=1, . . . , N_{A}, ≥1 from the target quantum circuit P and a plurality of execution strategies Sₘ, i=1, . . . , M, each execution strategy being associated with a value λₘ of a noise strength λ. The classical computer 10 may be operative to receive these instructions, for example, via a user input. The classical computer 10 may be further operative to derive the at least one auxiliary quantum circuit from the quantum circuit P in accordance with the received instructions and to transmit the instructions specifying the target quantum circuit P, the at least one derived auxiliary quantum circuit Aᵢ, i=1, . . . , N_{A}, and the plurality of execution strategies Sₘ, m=1, . . . , M to the quantum processor 1 via the interface 50.

The quantum processor 1 comprises a register of qubits 2, means for applying quantum gates 3 and measurement means 4. Furthermore, the quantum processor 1 also comprises a classical processor/controller 5 for control of the means for applying quantum gates 3 and measurement means 4.

The register of qubits may comprise n≥2 qubits. The type of qubits is not limited for the invention, and may comprise superconducting qubits, ion qubits, photonic qubits, atomic qubits, but is not limited to this. The means for applying quantum gates 3 is operative to apply quantum gates acting on a small number of qubits of the qubit register. For example, the means for applying quantum gates 3 may be operative to apply a sequence of single-qubits gates and two-qubit gates according to instructions specifying the quantum circuit and its execution strategy received from the controller 5. The measurement means 4 may be operative to perform single qubit measurements. In one example, the measurement basis may be determined by control of the controller. In one embodiment, the measurement may be performed in the computational basis.

The quantum processor 1 is further operative to receive, via the interface 50, instructions specifying the target quantum circuit and the auxiliary quantum circuits Aᵢ and the respective execution strategy. These instructions include instructions related to the initial state of the register of qubits, the sequence of single-qubit gates and two-qubit gates to be applied to the register of qubits and the observable O to be measured by the measurement means 4. Then, the quantum processor 1 may be operative, by control of the controller, to execute the quantum circuit as specified by the instructions. That is, the quantum processor 1 may be operative to prepare the register of qubits 2 in the initial state specified by the instructions, to apply the a sequence of quantum gates by the mean for applying quantum gates 3, and to measure the value of the predetermined observable by the measurement means 4. The quantum circuit may be repeatedly executed by the quantum processor and the measurement outcomes for the observable O may be processed by the controller/classical processor 5 to thereby calculate an estimator value, respectively an auxiliary estimator value of the observable O. The quantum processor 1 may be further operative to transmit the determined estimator value, respectively auxiliary estimator value, via the interface 50 to the classical computer 10.

A computer program is stored on the memory means 12 of the classical computer 10. The computer program comprises instructions, which, when the program is executed by the classical computer 10, cause the computer to simulate an execution of each auxiliary quantum circuit Aᵢ to thereby obtain a noise-free estimator value E_{O}(Aᵢ,0) of the expectation value of the observable O. As the auxiliary quantum circuit(s) is/are efficiently classically simulable, the simulation of the execution may be performed in a computation time which is polynomial in the number n of qubits.

Furthermore, the computer program comprises instructions, which, when the program is executed by the classical computer 10, cause the computer to transform an original set

$${\{ {E}_{O} ( P , {λ}_{m} ) \}}_{m = 1}^{M}$$

of the estimator values E_{O}(P,λₘ) for each value λₘ on the basis of the auxiliary estimator values E_{O}(Aᵢ,0), E_{O}(Aᵢ,λₘ) to thereby obtain a set of transformed estimator values

$${\{ {E}_{T} ( {λ}_{m} ) \}}_{m = 1}^{M}$$

such that the transformed estimator values have a reduced value for a measure of dispersion compared to the estimator values of the original set.

The computer is further operative to receive a user input with instructions defining a fitting model for a data set

$${\{ ( {λ}_{m} , {E}_{T} ( {λ}_{m} ) ) \}}_{m = 1}^{M}$$

of M tuples of the values λₘ of the noise strength λ and the associated transformed estimator values E_{T}(λₘ). The computer program further comprises instructions, which, when the program is executed by the classical computer 10, cause the computer to fit said fitting model to the data set to thereby estimate the zero-noise limit, λ=0 and to thereby infer an error mitigated value E_{EM}(P,0) of the estimator value of the expectation value of the observable O. The zero-noise limit may be estimated by extrapolation in one example.

FIG. 2 depicts a flow chart of method steps of an embodiment of the method according to the first aspect of the present invention. The method starts at 101 with the selection of a target quantum circuit P. The target quantum circuit P may be selected by a user of the method. The target quantum circuit P may be related to the solution of a specific computational problem. An example of such a computational problem is shown in FIG. 3.

FIG. 3a schematically depicts five qubits (solid circles) which interact (dashed lines) by a transverse Ising Hamiltonian H with coupling strength g=2. The explicit form of the Hamiltonian is shown in FIG. 3a.

$${σ}_{X}^{j}$$

is the Pauli X-matrix acting on the qubit j, and

$${σ}_{Z}^{j} {σ}_{Z}^{{j}^{′}}$$

is a coupling term between nearest neighbor qubits j and j as indicated by the dashed lines in FIG. 3a. The computational problem is to find the ground state energy of said model on a quantum processor 1. To this end, a QAOA (Quantum Approximate Optimization Algorithm)-type target quantum circuit is used to find the ground state energy of the transverse Ising model. The target quantum circuit comprises a target gate sequence comprising single-qubit rotations around the X, Y and Z axis and controlled-Z operations. The noise profile of the quantum processor is summarized in FIG. 3b.

FIG. 3c shows the optimization history for the ground state energy estimator value of the expectation value of the observable O (which is associated with the Hamiltonian H). A comparison of the noisy QAOA ground state energy with the exact ground state energy reveals that the relative error in the ground state energy is around 30%.

Returning to FIG. 2, at 102, N_{A}=2 near-Clifford circuits are derived from the quantum circuit P. Examples how the near-Clifford circuits may be derived are shown in FIGS. 4a-4c. FIGS. 4b and 4c depict examples of auxiliary quantum circuits derived from the target quantum circuit shown in FIG. 4a. FIG. 4a is a schematic representation of the target gate sequence of the target quantum circuit P, for example, the target quantum circuit for the computational problem shown in FIG. 3. FIG. 4a shows a target gate sequence wherein a sequence of single-qubit gates R (ref. 20) and two-qubit gates 21 is applied to five qubits. In general, the single-qubit gates are different for different qubits. The single-qubit gates 20 may be rotations around the X, Y and Z axes. In the target gate sequence shown in FIG. 4a, it is assumed that all single-qubit gates are non-Clifford gates. The two-qubit gates 21 may be controlled Z-gates or controlled-NOT gates. The auxiliary gate sequence of the auxiliary quantum circuit shown in FIG. 4b is derived by replacing all non-Clifford gates in the target gate sequence shown in FIG. 4a by the closest Clifford gate (C) 30. The auxiliary gate sequence of the auxiliary quantum circuit shown in FIG. 4c is derived from the target gate sequence shown in FIG. 4a by removing all single qubit gates without a replacement.

Returning to FIG. 2, at 103, M=3 execution strategies S₁, S₂, S₃ are selected. The execution strategies are respectively associated with values λ₁=1, λ₂=3, λ₁=5 of the noise strength. Possible ways to select the execution strategies are shown in FIGS. 5a-5c. If the complete gate sequence of the target or auxiliary quantum circuits is represented as a unitary U (see FIG. 5a), the execution strategy Si is executing the circuit realizing the unitary U followed by executing (i−1)—times the gate sequence represented by U^{†}U. That is, the execution strategy S₁ is executing the target or auxiliary gate sequence realizing the unitary U, the execution strategy S₂ is realizing the unitary U followed by U^{†}U. If the execution strategy S₁ has a value λ=1 of the noise strength, the execution strategy S₂ (see FIG. 5b) has the associated value λ₂=3 of the noise strength λ. The execution strategy S₃ (see FIG. 5c) is realizing the unitary U followed by 2 times the gate sequence represented by U^{†}U. That is, in total the unitary UU^{†}UU^{†}U is realized. The execution strategy S₃ has the associated value λ₃=5 of the noise strength λ.

At 104, the quantum circuit P and the auxiliary quantum circuits A₁ and A₂ are executed repeatedly (plurality of shots) by the quantum processor in accordance with each of the execution strategies Sₘ, m=1, 2, 3 to thereby obtain the estimator values E_{O}(P,λₘ) and the auxiliary estimator values E_{O}(Aᵢ,λₘ).

At 105, each of the auxiliary quantum circuits A₁ and A₂ is executed by a classical computer to thereby obtain a noise-free auxiliary estimator value E_{O}(Aᵢ,0). As the auxiliary quantum circuits are efficiently classically simulable, the estimator values may be obtained in polynomial time in the number of qubits.

At 106, the estimator values E_{O}(P,λₘ) are transformed according to

$${E}_{T}^{( k )} ( {λ}_{m} ) = {E}_{O} ( P , {λ}_{m} ) {W}^{( k )} ( {λ}_{m} ) ,$$

k=1, 2, wherein the re-scaling function W^{(k)}(λₘ) is either

$${W}^{( 1 )} ( {λ}_{m} ) = {( \frac{{E}_{O} ( {A}_{1} , 0 )}{{E}_{O} ( {A}_{1} , {λ}_{m} )} )}^{n} or$$

$${W}^{( 2 )} ( {λ}_{m} ) = \frac{{c}_{1}}{{c}_{1} + {c}_{2}} ( \frac{{E}_{O} ( {A}_{1} , 0 )}{{E}_{O} ( {A}_{1} , {λ}_{m} )} ) + \frac{{c}_{2}}{{c}_{1} + {c}_{2}} {( \frac{{E}_{O} ( {A}_{2} , 0 )}{{E}_{O} ( {A}_{2} , {λ}_{m} )} )}^{2}$$

with real parameters n, c₁ and c₂.

At 107, the parameter n, respectively the parameters c₁ and c₂ are determined so as to minimize the mean absolute difference of the transformed estimator values, i.e.,

$${\sum }_{i , j} \vert {E}_{T}^{( k )} ( {λ}_{i} ) - {E}_{7}^{( k )} ( {λ}_{j} ) \vert ,$$

k=1, 2. In this way, optimal parameters n, respectively c₁ and c₂ are obtained defining optimal re-scaling functions W^{(k)}*(λₘ).

Two data sets

$${\{ ( {λ}_{m} , {E}_{T}^{( k ) *} ( {λ}_{m} ) ) \}}_{m = 1}^{M} ,$$

k=1, 2, are formed which comprise the transformed estimator values

$${E}_{T}^{( k ) *} ( {λ}_{m} )$$

obtained with the optimal re-scaling functions W^{(k)}*(λₘ) according to

$${E}_{T}^{( k ) *} ( {λ}_{m} ) = {E}_{O} ( P , {λ}_{m} ) {W}^{( k ) *} ( {λ}_{m} )$$

at 108. Furthermore, a fitting model is selected for the data sets, and the data sets are fitted to the fitting model. Thereby, the noise mitigated estimator values

$${E}_{E M}^{( k )} ( P , 0 )$$

for the estimator value of the observable O may be inferred. For example, the model may be extrapolated to the zero-noise limited which leads to an estimation of the value

$${E}_{T}^{( k ) *} ( 0 ) .$$

As the value of the re-scaling functions W^{(k)}*(0)=1 is 1 in the zero-noise limit, the error mitigated estimator values

$${E}_{E M}^{( k )} ( P , 0 )$$

are respectively equal to

$${E}_{T}^{( k ) *} ( 0 ) , i . e . , {E}_{E M}^{( k )} ( P , 0 ) = {E}_{T}^{( k ) *} ( 0 ) .$$

FIG. 6 depicts the influence of the inaccuracy in the quantification of the value of the noise strength on the result of the error mitigation technique. It is assumed that the first execution strategy is associated with a value of λ₁=1, and that the other values of the noise strength are associated with an inaccuracy δ, i.e., λ₂=3(1+δ), λ₃=5(1+δ). The influence of the inaccuracy δ on the relative bias error is depicted in FIG. 6 for three different error mitigation techniques. ZNE denotes the Zero Noise Extrapolation as introduced in K. Temme, et al, Physical Review Letters 119, 180509 (2017). eZNE denotes the error mitigation method according to the present invention with a transformation of the estimator values with the re-scaling function

$${W}^{( 1 )} ( {λ}_{m} ) = {( \frac{{E}_{O} ( {A}_{1} , 0 )}{{E}_{O} ( {A}_{1} , {λ}_{m} )} )}^{n}$$

wherein n=1 is fixed. NREM V1 denotes the error mitigation method according to the present invention with a transformation of the estimator values using the re-scaling function

$${W}^{( 1 )} ( {λ}_{m} ) = {( \frac{{E}_{O} ( {A}_{1} , 0 )}{{E}_{O} ( {A}_{1} , {λ}_{m} )} )}^{n} ,$$

wherein the real parameter n is optimized to minimize the dispersion of the transformed estimator values. The dispersion may be proportional to the mean absolute difference. It follows from FIG. 6 that the bias error is smallest for NREM V1 where the parameter n in the re-scaling function W⁽¹⁾(λₘ) is optimized to minimize the dispersion.

In FIG. 7 values of the ground state energy for the transverse Ising model of FIG. 3a (squares: value of the estimator of the ground state energy for ZNE; triangles: values of the transformed estimator values for the ground state energy for NREM −V1 (defined in the explanation of FIG. 6 above) are plotted for the three values of the noise strength (λ₁=1, λ₂=3, λ₃=5). It follows directly from FIG. 7 that the dispersion for the transformed estimator values of NREM −V1 is significantly reduced compared to the dispersion for the estimator values used for the ZNE method.

Returning to FIG. 2, at 108 a fitting model is selected for the data set

$${\{ ( {λ}_{m} , {E}_{T}^{( k )} ( {λ}_{m} ) ) \}}_{m = 1}^{M} ,$$

and the data set is fitted to the fitting model. It is obvious from FIG. 7 that fitting the transformed estimator values to a fitting model results in a very good estimation of the exact ground state energy (“Exact”, circle in FIG. 7). A linear fitting model or another low-degree polynomial may be a good choice for the fitting model. For the ZNE method, the dispersion of the data is however, significant, and results in a non-negligeable bias error when an extrapolation of the model to the zero-noise limit is used to infer the error mitigated value of the ground state energy.

1. A method for mitigating errors caused by noise in a target quantum circuit P executed by a quantum processor, said method comprising:
deriving from said target quantum circuit P at least one auxiliary quantum circuit Aᵢ i=1, . . . , N_{A}≥1, each auxiliary quantum circuit being efficiently classically simulable;
selecting a plurality of execution strategies Sₘ, m=1, . . . , M for the quantum circuits, each execution strategy corresponding to an execution of the quantum circuit with an associated value λₘ≥1 of a noise strength λ;
for each execution strategy Sₘ, executing the target quantum circuit P by said quantum processor according to the execution strategy to thereby obtain an estimator value E_{O}(P,λₘ) of an expectation value of an observable O associated with the value λₘ of said execution strategy Sₘ, and executing each auxiliary quantum circuit Aᵢ by said quantum processor according to the execution strategy Sₘ to thereby obtain an auxiliary estimator value E_{O}(Aᵢ,λₘ) of the expectation value of the observable O associated with the value λₘ of said execution strategy Sₘ;
simulating, by a classical computer, an execution of each auxiliary quantum circuit Aᵢ to thereby obtain a noise-free auxiliary estimator value E_{O}(Aᵢ,0) of the expectation value of the observable O;
transforming an original set
$${\{ {E}_{O} ( P , {λ}_{m} ) \}}_{m = 1}^{M}$$
of the estimator values E_{O}(P,λₘ) for each value λₘ on the basis of the auxiliary estimator values E_{O}(Aᵢ,0), E_{O}(Aᵢ,λₘ) to thereby obtain a set of transformed estimator values
$${\{ {E}_{T} ( {λ}_{m} ) \}}_{m = 1}^{M}$$
such that the transformed estimator values have a reduced value for a measure of dispersion compared to the estimator values of the original set;
defining a fitting model for a data set
$${\{ ( {λ}_{m} , {E}_{T} ( {λ}_{m} ) ) \}}_{m = 1}^{M}$$
of M tuples of the values λₘ of the noise strength λ and the associated transformed estimator values E_{T}(λₘ), fitting said fitting model to the data set to thereby estimate the zero-noise limit, λ=0 and to thereby infer an error mitigated value E_{EM}(P,0) of the estimator value of the expectation value of the observable O.

2. The method of claim 1, wherein transforming said original set
$${\{ {E}_{O} ( P , {λ}_{m} ) \}}_{m = 1}^{M}$$
comprises multiplying each estimator value E_{O}(P,λₘ) of said set with a value W(λₘ) of a re-scaling function W which depends on the auxiliary estimator values, E_{T}(P,λₘ)=W(λₘ)E_{O}(P,λₘ), wherein preferably the value of the re-scaling function is 1 in the zero-noise limit λ→0.

3. The method of claim 2, wherein said re-scaling function W is a member of a parametric family of functions W_{α} with a real parameter α, and said method further comprises determining an optimal value α* for said parameter α such that the dispersion of the transformed estimator values transformed with the function W_{α*} is minimized.

4. The method of claim 3, wherein said real parameter α comprises 2N_{A}≥1 real parameters nᵢ and cᵢ, i=1, . . . N_{A}, the re-scaling function W is a member of the parametric family of functions
$${W}_{\{ {c}_{i} , {n}_{i} \}} ( {λ}_{m} ) = \frac{1}{{\sum }_{i = 1}^{{N}_{A}} {c}_{i}} {\sum }_{i = 1}^{{N}_{A}} {{c}_{i} ( \frac{{E}_{O} ( {A}_{i} , 0 )}{{E}_{o} ( {A}_{i} , {λ}_{m} )} )}^{{n}_{i}} ,$$
and wherein at least one of the parameters nᵢ and/or at least one of the parameters cᵢ is determined so as to minimize the dispersion of the transformed estimator values.

5. The method of claim 1, wherein said fitting model comprises a model function which is a low-degree polynomial in the noise strength or an exponential function in the noise strength.

6. The method of claim 1, wherein the measure of dispersion is proportional to the variance, the standard deviation or the mean absolute difference.

7. The method of claim 1, wherein said target quantum circuit P comprises a target gate sequence with a first quantum gate, said first quantum gate acting on at least one qubit, and wherein deriving at least one of said auxiliary circuits Aₐ from said target quantum circuit P comprises replacing said first quantum gate by a replacement gate thereby obtaining an auxiliary gate sequence, said replacement gate acting preferably on the same qubits as the first quantum gate.

8. The method of claim 7, wherein said first quantum gate comprises a non-Clifford gate, and said replacement gate comprises a Clifford gate.

9. The method of claim 8, wherein said Clifford gate is the closest Clifford gate to said first quantum gate or wherein an angle of said Clifford gate is randomly selected.

10. The method of claim 7, wherein said target gate sequence comprises a plurality of non-Clifford gates, and wherein deriving at least one of said auxiliary quantum circuits from the target quantum circuit comprises replacing each non-Clifford gate of a first number of the non-Clifford gates by a Clifford gate and keeping each non-Clifford gate of a second number of the non-Clifford gates.

11. The method of claim 7, wherein the target gate sequence comprises a third quantum gate and deriving of at least one of said auxiliary quantum circuits Aₐ from said target quantum circuit P comprises removing the third quantum gate.

12. The method of claim 7, wherein a first execution strategy Sᵢ associated with a first value λᵢ of the noise strength λ comprises an implementation of a second quantum gate of said gate sequence by an application of a control pulse C during an application time T by said quantum processor, and wherein a second execution strategy associated with a second value λⱼ of the noise strength λ which is larger than the first noise strength, λⱼ>λ, comprises an implementation of the second quantum gate by an application of a recalibrated control pulse C′ for a stretched application time T′=T·λⱼ/λᵢ by said quantum processor.

13. The method of claim 7, wherein a third execution strategy comprises adding an additional gate sequence corresponding to an identity operation to said gate sequence of said quantum circuit, wherein preferably the additional gate sequence corresponds to a product of a unitary operation Uᵢ and its hermitian conjugate
$${U}_{i}^{†} ,$$
wherein the unitary operation or its hermitian conjugate corresponds to at least one gate of said gate sequence of said quantum circuit.

14. The method of claim 7, wherein a fourth execution strategy comprises executing said gate sequence of said quantum circuit followed by executing the inverse of said gate sequence.

15. A computing system, said computing system comprising a classical computer and a quantum processor, wherein said computing system is configured to carry out the method of claim 1.

16. A computer program product including instructions which, when the program is executed by a computer system comprising a classical computer and a quantum processor, cause the computer system to carry out the method of claim 1.

17. A computer-readable data carrier having stored thereon the computer program product of claim 16.
